(19) United States
(12) Patent Application Publication
(10) Pub. No.: US 2017/0364226 A1
(43) Pub. Date: Dec. 21, 2017

(54) Application for Core Drilling

(71) Applicant: EVCO Plastics, DeForest, WI (US)

(72) Inventor: Steven L. Evans, Madison, WI (US)

(21) Appl. No.: 15/695,590

(22) Filed: Sep. 5, 2017

Related U.S. Application Data
(63) Continuation of application No. 14/032,898, filed on Sep. 20, 2013.
(60) Provisional application No. 61/704,186, filed on Sep. 21, 2012.

(51) Int. Cl. G06F 3/0484; G06Q 50/28; E21B 25/00

(52) U.S. Cl. CPC G06F 3/0484; G06Q 50/28; E21B 25/005

(57) ABSTRACT

A software application for use on a mobile phone or other computerized hardware system for collecting geological core samples and assigning these samples to boxes is disclosed. The mobile application can include a scanner such as a bar code scanner for reading identifying data from boxes storing cores, and also provides the ability to print barcodes for identifying boxes of cores at a printer.

This application is a continuation of U.S. patent application Ser. No. 14/032,898 filed on Sep. 20, 2013, which claims the benefit of U.S. Provisional patent application Ser. No. 61/704,186 filed on Sep. 21, 2012 and titled “Application for Core Drilling,” all of which are hereby incorporated by reference in their entirety.

### BACKGROUND

Core drills are used to acquire core samples from the ground which can be used and examined by geologists to evaluate the earth in the vicinity of the acquired sample, including mineral percentages and stratigraphic contact points. The core sample is a specimen of mud, soil, rock, or similar material, typically taken in the form of a cylindrical block, preserving the arrangement of its contents. The sample provides an opportunity to look inside geological formations, the ocean floor, and other environments. The preservation of a solid block shows the distribution of materials inside the formation and can highlight features like a thin layer of different material sandwiched between larger layers. Core samples are useful for mineral exploration, scientific research, geology, and oceanography, and can be used, for example, to give exploration companies the information necessary to begin or abandon mining operations in a particular area.

To properly evaluate core samples it is very important to be able to identify the location where the core was acquired, and to assure that the collected material is not cross-contaminated with other samples. To assure proper correlation of core samples and location information, and to limit cross-contamination and damage to samples, special core boxes and corresponding labels are used.

Properly labeling core boxes, however, can be difficult, particularly in the field. The present invention provides, among other things, a simplified method for identifying holes drilled in obtaining geological samples, segments, and a box containing those pieces of data.

### SUMMARY

In one aspect, the present invention provides a computerized system for tracking data related to core drilling. The system includes a user interface, a display, a communications device, a memory component, and a processor in communication with the user interface, the display, the communications device and the memory. The processor is programmed to receive commands from a user accessing the user interface to store data corresponding to a drill hole in the memory, receive commands from a user accessing the user interface store data identifying a box in the memory, correlate the data corresponding to the drill hole to the data identifying the box in the memory, and communicate data through the communications device to enable printing of a bar code to identify the box.

In another aspect, the computerized system further comprises a global positioning system in communication with the processor, and the processor is programmed to receive user input to the store global positioning system data defining a location of the drill hole in the memory. The processor can be further programmed to provide a notes screen on the display, receive notes input by a user through the user interface, and to identify a box for storing the drill holes.

The computerized system can also include a camera in communication with the processor, and ne programmed to decode a barcode that is imaged by the camera to identify a box. 16. The processor can be programmed to prompt the user to scan a barcode on a new box by acquiring an image using a camera with the barcode label positioned within the view finder to allow at least one of decoding the barcode and acquiring an image of the barcode.

The system can also be programmed to prompt the user to enter segment data and to store the segment data in memory.

In another aspect, the processor can be programmed to produce a main application screen on the display providing a user the option of selecting a scan option, a print option, and a drill holes option that can be selected by the user through the user interface.

The processor can also be programmed to prompt the user to enter at least one of a company name, a property, a drill company, a drill name, hole number, target depth; and to enter at least one of GPS data and UTM data.

The processor can be further programmed to prompt the user to enter notes into memory through access to a text editor stored in memory, and can also be programmed to prompt the user to identify a box corresponding to the drilled core. The box identified by the user can be selected to be one of an existing box and a new box.

The processor can be further programmed to prompt the user to enter a start depth and an ending depth for the drilling, enter a hole diameter, and provide a box location. The processor can be further programmed to prompt the user to use the camera to acquire an image of the box. The processor is further programmed to prompt the user to enter segment data including a core to segment, an end depth, and an amount of recovered amount. The processor can be further programmed to prompt the user to cycle from a box content page to a segment page until a box is full.

The computerized system can graphically display box contents including client information, hole numbers, box numbers, and total amount of material recovered from the hole on the display.

These and other aspects of the present disclosure appear from the following description. In that description reference is made to the accompanying drawings in which there is shown by way of illustration preferred embodiments of the invention. However, the claims should be looked to in order to judge the full scope of the invention.

### BRIEF DESCRIPTION OF THE DRAWINGS

FIG. 1 is a flow chart illustrating the steps of a software application for labeling core samples and corresponding boxes.

FIG. 2 is a screen shot of a main application screen.

FIG. 3 is a screen shot of a display screen allowing the user to identify a box in which the drilled core from the hole will or has been placed.

FIG. 4 is a screen shot of a display screen allowing the user to enter notes.

FIG. 5 is a screen shot of a display screen allowing a user to select a box.

FIG. 6 is a screen shot of a display screen allowing a user to enter box data.

FIG. 7 is a screen shot of a display screen allowing a user to scan a new box.

FIG. 8 is a screen shot of a display screen allowing a user to enter hole data to track the box contents.

FIG. 9 is a screen shot of a display screen for entry of segment data.

FIG. 10 is a hardware block diagram of a device capable of executing the application of FIG. 1.

### DETAILED DESCRIPTION OF THE DISCLOSURE

The present disclosure provides, among other things, a software application for use on a mobile phone or other computerized hardware system that is used for collecting geological core samples and assigning these samples to boxes. The hardware and software application can include a scanner such as a bar code scanner for reading identifying data from boxes storing cores, and also provides the ability to print barcodes for identifying boxes of cores.

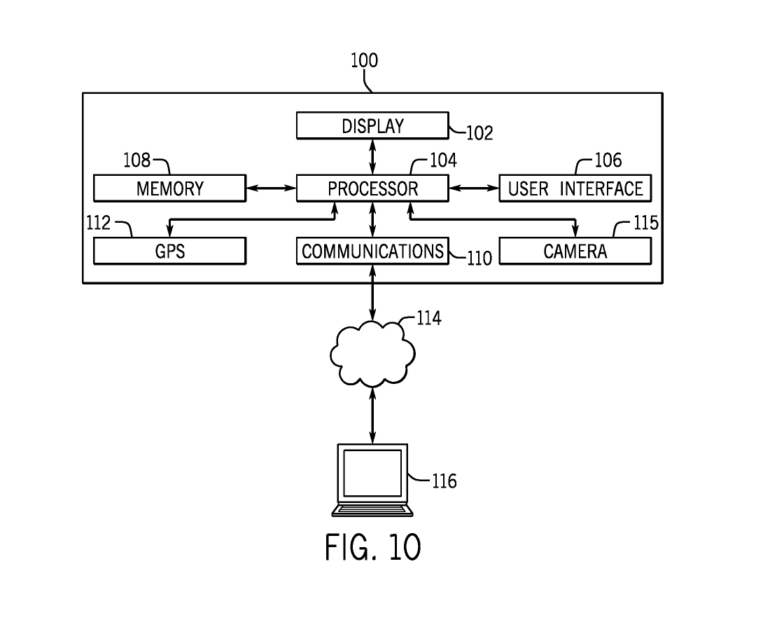

Referring first to FIG. 10, a hardware block diagram for a computerized system useful in the present application, such as a cellular telephone, tablet, computer, laptop, personal digital assistant, or other device capable of running the core drilling and box application is shown. Generally the hardware 100 comprises a display 102, processor 104, user interface 106, a memory 108, and a communication system 110. Preferably the system also includes a GPS and or other position location identifying device 112 and a camera 115. A communication system 110 can be a wireless or wired communication system such as a cellular communications network, LAN, WAN, Ethernet or other system which communicates, for example, to an external server 116 via a network or the internet 114 enabling downloading applications to the hardware 100. Applications can be downloaded from the server 116 into the memory 108 of hardware 100 and accessed by a processor 104 which displays screens on display 102. A user can make selections by way of user interface 106 which can be, for example, a keyboard, a touch screen, or various other types of devices which will be known to those skilled in the art. A camera 115 can be used in conjunction with software to provide a scanning function for scanning barcodes and other identifying symbols and it can also be used to acquire images of boxes for storing the cores as described below.

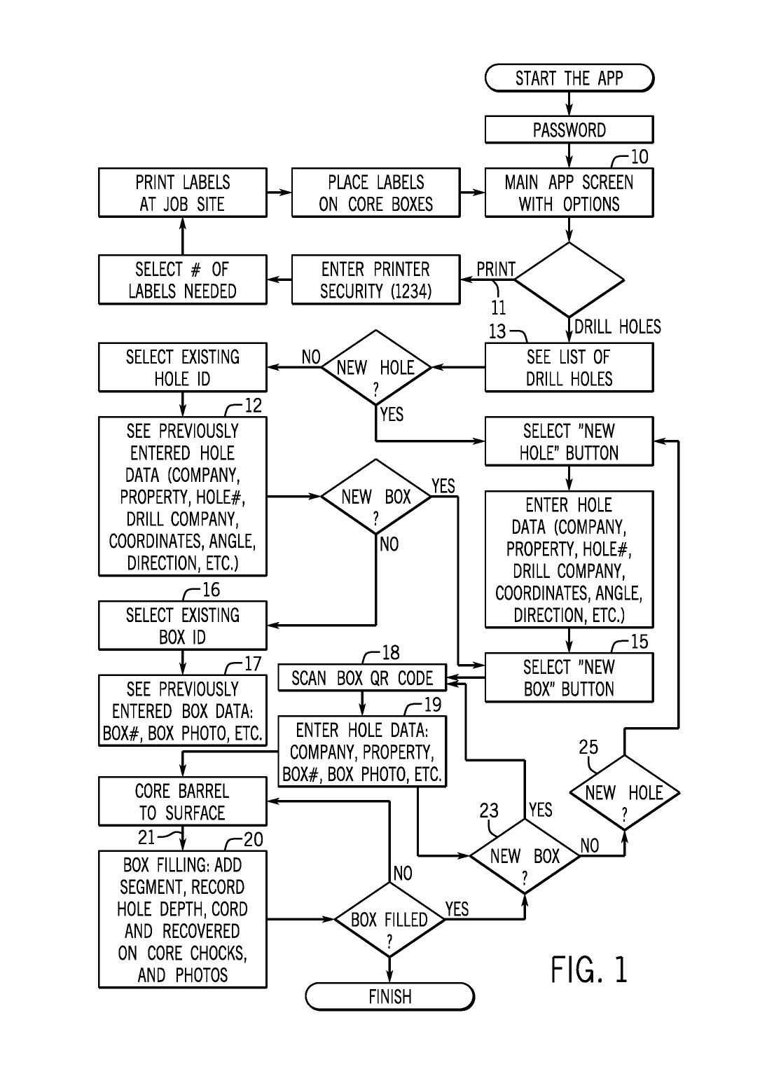

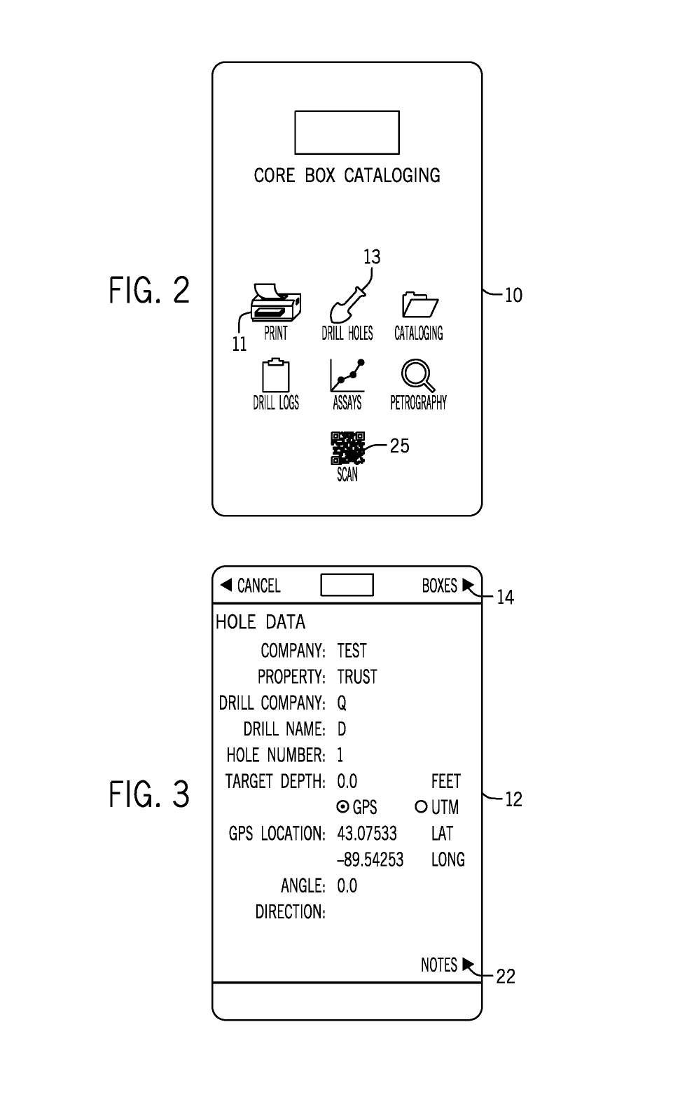

Referring now to FIG. 1, an application flow chart is shown. A user starts the application generally by selecting the application using the user interface 106 of hardware 100 by, for example, selecting an icon from the display 102. Optionally, a password can be required for entering into the system. Upon entry into the system, the user accesses a main application screen 10, shown in FIG. 2, which provides a number of possible options including a scan option, a print option 11, a drill holes option 13. Other options such as cataloging, petrography, assaying, and drill logs can also be provided. When the user selects the print icon 11, hardware 100 can access a printer through communications link 110 and print labels at a job site which thereafter can be placed on core boxes for identifying the geological samples or cores within the box. Alternatively, the user can select a drill holes icon 13 which allows the user to enter data about cores acquired from a hole.

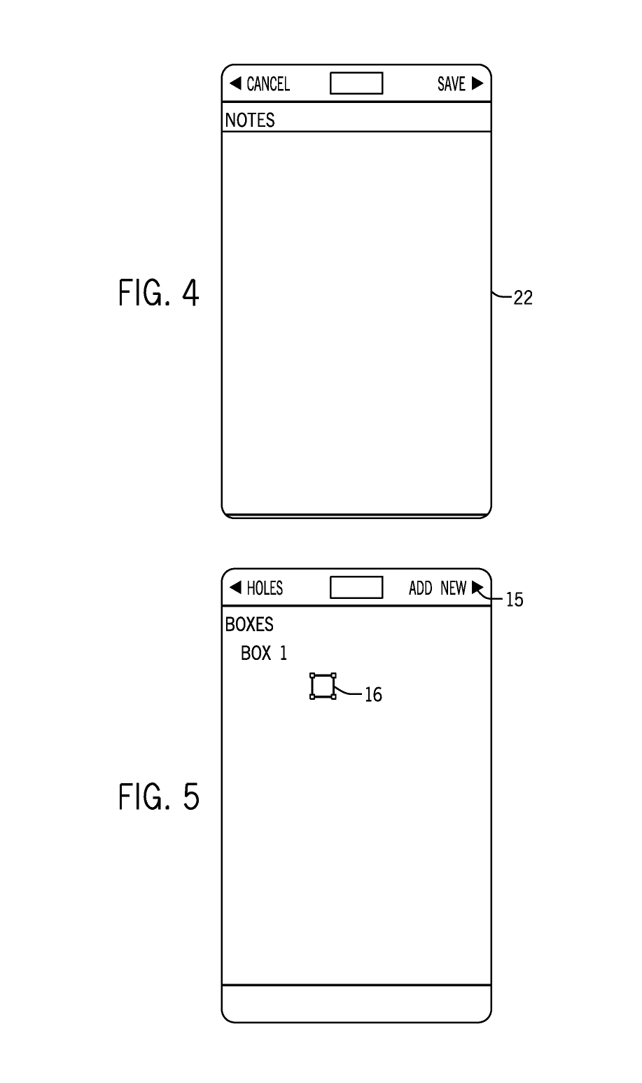

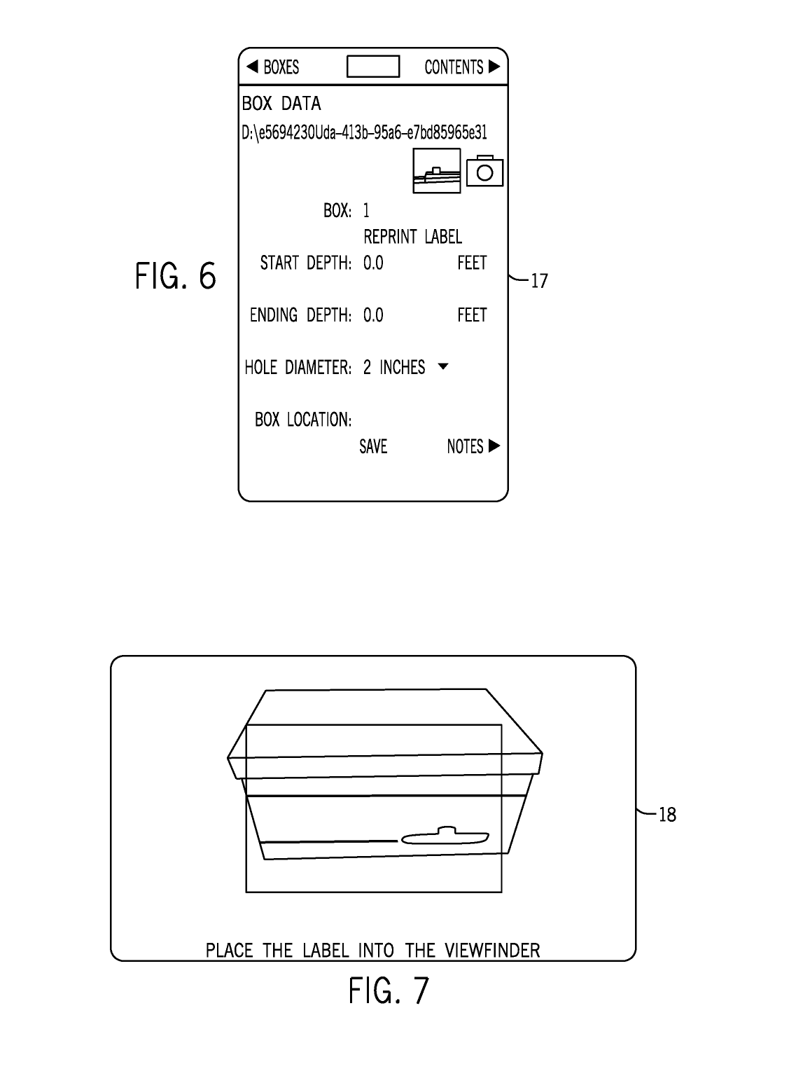

Referring still to FIG. 1, the user can select to enter data for a new hole or access data from an existing hole. In either case, a display screen 12, as shown in FIG. 3, is presented to the user. This display screen allows the user to enter a company name, a property, a drill company, a drill name, hole number, target depth, and add GPS data, UTM data, or both. The user can also enter an angle and direction of the drill process. The user can also access a notes button 22, which allows the user to access a notes page and enter notes about the hole using a text editor incorporated into the hardware 10, as shown in FIG. 4. After this data is acquired, the user can, referring again to FIG. 3, select a boxes button 14 which allows the user to identify a box in which the drilled core from the hole will or has been placed. The user can optionally select an existing box 16 from the screen shown in FIG. 5 or add a new box by selecting the new box button 15 on FIG. 5. When the user selects an existing box by activating icon 16, the user accesses a box data screen 17 shown in FIG. 6. Here user can enter or scan a barcode of the box using camera 13, enter start depth and ending depth data for the drilling, enter a hole diameter, and provide a box location. As discussed above, notes can be added by accessing an icon on the screen. By using the camera 13, user can also acquire an image of the box.

Referring now to FIG. 7, when the user instead elects to acquire a new box, the user can scan a barcode on the box by acquiring an image using the camera 13 as shown in FIG. 7. Here the barcode label is positioned within the view finder to allow decoding of the barcode and/or acquisition of an image of the barcode.

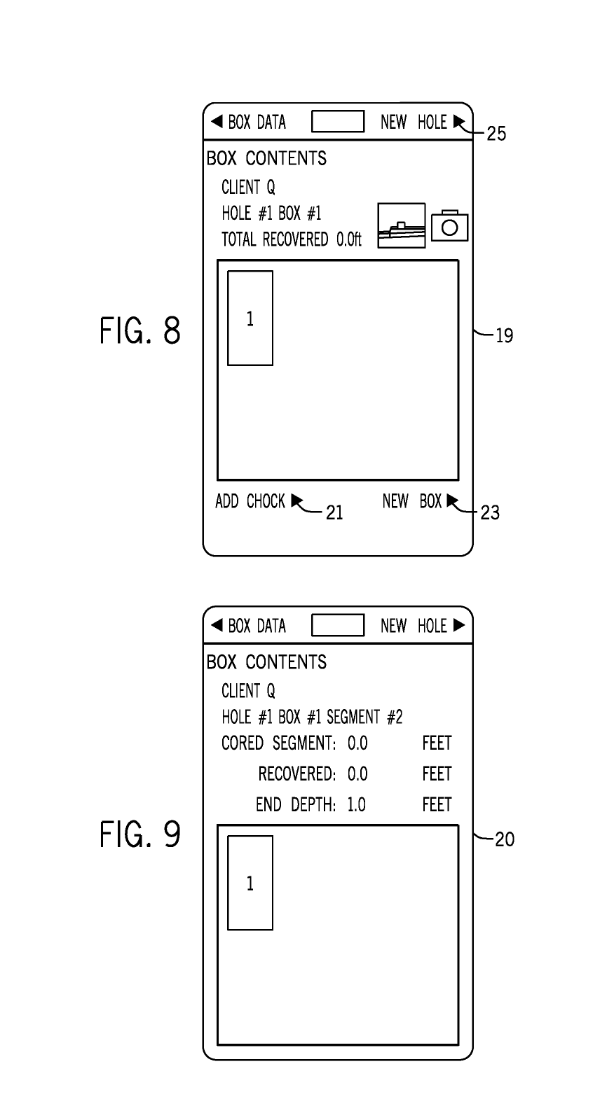

Referring now to FIG. 8, after the new box is added, the user accesses a screen 19 which enables the user to enter hole data to track the box contents. When adding segments of a drilling, the user clicks the add chock icon 21. When the user drills a new hole, the user can click new hole icon 25, and when the user chooses to add a new box, he can click the new box icon 23. The box contents can be displayed graphically, as shown, and can include client information and hole numbers, box numbers, and total amount of material recovered from the hole.

Referring now to FIG. 9, when a segment or chock is added, the user is prompted for segment data as shown in the entry screen 20. The user enters three pieces of data: the core to segment, the end depth, and recovered amount of material. An icon illustrating which the segment being entered is presented for their reference. Users will continue to cycle from box content page to the segment page until a box is full, and therefore between steps 19 and 20 as shown in the flow chart of FIG. 1.

The disclosed application, therefore, allows a user to identify holes drilled in obtaining geological samples. The core is acquired through those geological samples including segments and a box containing those pieces of data. The boxes can also be scanned for identification purposes and barcode labels can be printed from the application as described above.

It should be understood that the methods and apparatuses described above are only exemplary and do not limit the scope of the invention, and that various modifications could be made by those skilled in the art that would fall within the scope of the invention. To apprise the public of the scope of this invention, the following claims are made:

I claim:

1. A computerized system comprising a cellular telephone for tracking data related to core drilling, the system comprising:
a user interface;
a display;
a communications device;
a memory component;
a global positioning system; and
a processor in communication with the user interface, the display, the communications device, the global positioning system, and the memory, the processor being programmed to:
prompt a user to input data via the user interface;
receive commands via the user interface to store data corresponding to a drill hole in the memory;
receive user input to store global positioning system data defining a location of the drill hole in the memory;
receive commands from via the user interface to store data identifying a box in the memory;
correlate the data corresponding to the drill hole to the data identifying the box in the memory; and
communicate data through the communications device to enable printing of a bar code to identify the box.

2. The computerized system of claim 1, wherein the processor is further programmed to provide a notes screen on the display, receive notes input by a user through the user interface, and to identify a box for storing one or more cores corresponding to the drill hole.

3. The computerized system of claim 1, further comprising a camera in communication with the processor, and wherein the processor is further programmed to decode a barcode that is imaged by the camera to identify a box.

4. The computerized system of claim 1, wherein the processor is further programmed to prompt the user to enter segment data and to store the segment data in memory.

5. The computerized system of claim 1, wherein the processor is programmed to produce a main application screen on the display providing a user the option of selecting a scan option, a print option, and a drill holes option that can be selected by the user through the user interface.

6. The computerized system of claim 1, wherein the processor is further programmed to prompt the user to enter at least one of a company name, a property, a drill company, a drill name, hole number, target depth.

7. The computerized system of claim 1, wherein the processor is further programmed to prompt the user to enter at least one of GPS data and UTM data.

8. The computerized system of claim 1, wherein the processor is further programmed to prompt the user to enter notes into memory through access to a text editor stored in memory.

9. The computerized system of claim 1, wherein the processor is further programmed to prompt the user to identify a box corresponding to the drilled core.

10. The computerized system of claim 9, wherein the box is one of an existing box and a new box.

11. The computerized system of claim 1, wherein the processor is further programmed to prompt the user to enter a start depth and an ending depth for the drilling, enter a hole diameter, and provide a box location.

12. The computerized system of claim 1, wherein the processor is further programmed to prompt the user to use a camera to acquire an image of the box.

13. The computerized system of claim 1, wherein the processor is further programmed to prompt the user to enter segment data including a core to segment, an end depth, and an amount of recovered amount.

14. The computerized system of claim 1, wherein the processor is further programmed to prompt the user to cycle from a box content page to a segment page until a box is full.

15. The computerized system of claim 1, wherein the processor is further programmed to prompt the user to scan a barcode on a new box by acquiring an image using a camera with the barcode label positioned within the view finder to allow at least one of decoding the barcode and acquiring an image of the barcode.

16. The computerized system of claim 1, wherein the processor is further programmed to selectively graphically display box contents including client information, hole numbers, box numbers, and total amount of material recovered from the hole.
